(19) United States
(12) Patent Application Publication
(10) Pub. No.: US 2007/0133986 A1
(43) Pub. Date: Jun. 14, 2007

(54) Physical coding sublayer apparatus and Ethernet layer architecture for network-based tunable wavelength passive optical network system

(76) Inventors: Kang Bok Lee, Daejeon-city (KR); Hyeon Ho Yoon, Daejeon-city (KR); Tae Yeon Kim, Daejeon-city (KR); Jeong Ju Yoo, Daejeon-city (KR); Byoung Whi Kim, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/636,048

(22) Filed: Dec. 8, 2006

(30) Foreign Application Priority Data
Dec. 9, 2005 (KR) 10-2005-0121000
Sep. 6, 2006 (KR) 10-2006-0085820

(51) Int. Cl. H04B 10/20

(52) U.S. Cl. 398/58

(57) ABSTRACT

Provided are a physical coding sublayer (PCS) apparatus and an Ethernet layer architecture for a network-based tunable-wavelength passive optical network (T-PON) system employing an Ethernet communications technology, and more particularly, to a PCS apparatus and an Ethernet layer architecture for supporting a series of initialization function of allocating wavelengths between an optical line terminal (OLT) and an optical network terminal (ONT) and arranging the allocated wavelengths. A PCS layer transmits and allocates wavelength information such that wavelengths for setting a link between an OLT and an ONT are allocated, optical wavelengths within the ONT are observed while a system operates to allow continuous control so that operating of the system can be stably maintained.

### CROSS-REFERENCE TO RELATED PATENT APPLICATIONS

This application claims the benefits of Korean Patent Application No. 10-2005-0121000, filed on Dec. 9, 2005, and Korean Patent Application No. 10-2006-0085820, filed on Sep. 6, 2006, in the Korean Intellectual Property Office, the disclosures of which are incorporated herein in their entirety by reference.

### BACKGROUND OF THE INVENTION

1. Field of the Invention

The present invention relates to a physical coding sublayer (PCS) apparatus and an Ethernet layer architecture for a network-based tunable-wavelength passive optical network (T-PON) system employing an Ethernet communications technology, and more particularly, to a PCS apparatus and an Ethernet layer architecture for supporting a series of initialization function of allocating wavelengths between an optical line terminal (OLT) and an optical network terminal (ONT) and arranging the allocated wavelengths.

2. Description of the Related Art

As the speed of Internet traffics becomes fast and broadcasting communications services are unified, a base for subscriber networks are changed into fiber-optic cables from copper wires.

As a future subscriber network technology, a wavelength division multiplexing (WDM)—passive optical network (WDM-PON) technology in which independent wavelengths are allocated by subscribers to increase a transmission band and links are constituted of only passive elements to improve the reliability of a transmission line has been proposed.

The WDM-PON technology which stands for a fiber to the home (FTTH) technology for connecting a telephone office to the home via fiber-optic cables, employs an Ethernet communications technology but requires a new function and a new apparatus.

In the WDM-PON technology, the structure of a system is changed according to functions and uses of light sources and in particular, a standardized Ethernet layer architecture needs to be changed.

WDM-based FTTH, that is, WDM-PON, makes communications between a central base station and a subscriber using respective wavelengths allocated to respective subscribers. WDM-PON has an advantage of providing independent and high-capacity communications services to every subscribers.

In addition, WDM-PON has excellent security and differs from a time division multiplexing (TDM) technology. In WDM-PON, modulation and demodulation of light sources are performed only for one subscriber. Thus, a light source having a low modulation speed and a low output and a receiver having a narrow bandwidth can be used in WDM-PON.

However, in WDM-PON, an inherent wavelength is allocated to each subscriber and a light source having a subscriber's inherent wavelength is needed. That is, ONTs each having a specific light source having a different wavelength for each subscriber should be prepared.

In WDM-PON, there are problems that a price of a system increases and a businessman should sort and control different ONTs.

To solve these problems, studies on wavelength-independent light sources, that is, studies on a technology in which a predetermined light source is not used in a predetermined wavelength for each subscriber but a tunable-wavelength light source that can be freely used regardless of a subscriber's position is used to adjust the wavelength of the light source according to the position of an ONT, have been proposed.

Such a technology has advantages that various kinds of light sources do not need to be prepared and various wavelengths can be accommodated at an ONT of a single platform.

A tunable-wavelength light source is located in an ONT of WDM-PON and the ONT of WDM-PON is connected to an array waveguide grating (AWG) of a remote node (RN) via an optical link.

Upstream optical modules of the ONT for providing a subscriber-side interface of WDM-PON should be arranged in predetermined wavelengths allocated to match an AWG disposed on a transmission line and to constitute an upstream transmission line.

Thus, a WDM-PON system should support a series of initialization function of allocating wavelengths to an upstream light source and arranging the allocated wavelengths when connecting networks of an ONT.

Physical coding sublayer (PCS) is a terminology defined by the IEEE 802.3 standard and performs the function of connecting various physical layer functions for Ethernet communications to medium access control (MAC) layers.

Functions of PCS are diversified according to Ethernet techniques and standards, and the currently-used layer architecture of Ethernet is standardized by IEEE 802.3.

FIG. 1 illustrates a layer architecture of Ethernet provided by IEEE802.3z 1000Base-X.

Physical coding sublayer (PCS) 101 connects a medium access control (MAC) layer and a physical medium attachment (PMA) 102 layer to GMII and TBI signals, respectively.

The PMA 102 converts parallel signals received from the PCS 101 into optical serial signals for long-distance transmission.

The Ethernet layer architecture shows that, as physical layers are changed, the architecture of layers that are lower than a physical medium dependent (PMD) layer is changed but the function of a PCS layer is not changed.

FIG. 2 illustrates a structure of a PCS apparatus of 1000Base-X illustrated in FIG. 1.

Functions of the PCS apparatus may largely include 8B/10B encoding, auto-negotiation, data reception/transmission, and semi-duplex mode support.

A PCS includes a transmitter 211, a receiver 212, a synchronization unit 213, a carrier sensor 214, and an auto-negotiation unit 215.

The function of the auto-negotiation unit 215 is to automatically set an optimum communication mode by exchanging information between two 1000Base-X devices sharing one link.

An auto-negotiation operation of 1000Base-X is performed for the purpose of automatically setting full-duplex/semi-duplex failover and use/nonuse of flow control.

A PMA 221 performs clock detection recovery and code synchronization on serial signals transmitted from an optical module, transmits the serial signals to a PCS functional unit through a ten bit interface (TBI), serializes parallel data transmitted from the PCS functional unit through the TBI, and transmits the parallel data to an optical module, as represented by the IEEE 802.3 standard.

However, the structure of the PCS apparatus has been gradually changed as a new technology for suggesting new network configuration emerges, even though the PCS apparatus and the new technology employ the same Ethernet communications technology.

In the WDM-PON technology, the structure of a system is changed according to functions and uses of light sources and in particular, a standardized Ethernet layer architecture needs to be changed.

A tunable-wavelength light source is located in an ONT of WDM-PON and the ONT of WDM-PON is connected to an array waveguide grating (AWG) of a remote node (RN) via an optical link.

Thus, a WDM-PON system should support a series of initialization function of allocating wavelengths to an upstream light source and arranging the allocated wavelengths when connecting networks of an ONT.

An initialization method of an existing tunable-wavelength ONT light source is an optical layer initialization method according to types of implementations.

The optical layer initialization method is a method of deciding wavelengths at an optical layer based on an optical signal transmitted from an OLT.

The OLT of the optical layer initialization method provides a seed light source (for example, a BLS source) for ONT light source locking or reflection. An ONT provides allocated wavelengths by using a locking or reflection mechanism based on a seed light source received from the OLT.

However, the optical layer initialization method should provide an additional seed light source and has limited factors that the ONT should accommodate a locking or reflection mechanism.

However, a tunable-wavelength laser (for example, planar lightwave circuit-external cavity laser (PLC-ECL)) based on a low-priced PLC that has been currently studied, uses independent electrical wavelength control signals, such as heat current and phase section current, without using such a locking or reflection mechanism. Thus, it is difficult to apply the optical layer initialization method to the tunable-wavelength laser.

In the ONT in which a light source for deciding optical wavelengths to be transmitted using an electrical wavelength control signal is located, an effective method for supporting an wavelength allocation function for wavelength initialization and an arrangement function through monitoring has not been suggested.

### SUMMARY OF THE INVENTION

The present invention provides a physical coding sublayer (PCS) apparatus and an Ethernet layer architecture for a network-based tunable-wavelength passive optical network (T-PON) system employing an Ethernet communications technology in which a series of initialization function of allocating wavelengths between an optical line terminal (OLT) and an optical network terminal (ONT) and arranging the allocated wavelengths is supported.

According to an aspect of the present invention, there is provided a PCS (physical coding sublayer) apparatus for a network-based T-PON (tunable-wavelength passive optical network) system of Ethernet including an ONT (optical network terminal) having a tunable-wavelength light source, the PCS apparatus including: a wavelength monitoring unit extracting wavelength information from a digital frame signal transmitted from the ONT and monitoring whether the wavelength information is identical with wavelength information allocated to a light source of the ONT; and an auto-identification unit, if the wavelength information is not identical with the wavelength information allocated to the light source of the ONT, adding wavelength control information to the digital frame signal and transmitting the wavelength control information to the ONT.

According to another aspect of the present invention, there is provided an Ethernet layer architecture for a network-based T-PON (tunable-wavelength passive optical network) system of Ethernet including an ONT (optical network terminal) having a tunable-wavelength light source, the Ethernet layer architecture including: a PMD (physical medium dependent) receiver receiving an optical signal transmitted from the ONT; a PCS (physical coding sublayer) extracting wavelength information from the received optical signal, monitoring whether the wavelength information is identical with wavelength information allocated to a light source of the ONT, and if the wavelength information is not identical with the wavelength information allocated to the light source of the ONT, adding wavelength control information to the digital frame signal; a PMA (physical medium attachment) changing the digital frame signal to which the wavelength control information is added and which has a parallel structure, into a serial structure; and a PMD transmitter converting the serial-structure digital frame signal into an optical signal and transmitting the optical signal.

According to another aspect of the present invention, there is provided a PCS (physical coding sublayer) apparatus for a network-based T-PON (tunable-wavelength passive optical network) system of Ethernet including an ONT (optical network terminal) having a tunable-wavelength light source, the PCS apparatus including: an auto-identification unit extracting wavelength control information from a digital frame signal transmitted from an OLT (optical line terminal); and a wavelength controlling unit converting the extracted wavelength control information into a current signal which is an analog signal, and controlling a wavelength of a tunable-wavelength light source of the ONT.

According to another aspect of the present invention, there is provided an Ethernet layer architecture for a network-based T-PON (tunable-wavelength passive optical network) system of Ethernet including an ONT (optical network terminal) having a tunable-wavelength light source, the Ethernet layer architecture including: a PMD (physical medium dependent) receiver receiving an optical signal transmitted from an OLT (optical line terminal); a PMA (physical medium attachment) converting the optical signal into a digital frame signal; a PCS (physical coding sublayer) extracting wavelength control information from the digital frame signal transmitted from the OLT and converting the extracted wavelength control signal into a current signal which is an analog signal, to control a wavelength of a tunable-wavelength light source of the ONT; and a PMD transmitter of the tunable-wavelength light source outputting an optical signal with a wavelength corresponding to the current signal.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a layer architecture of Ethernet provided by IEEE802.3z 1000Base-X;

FIG. 2 illustrates a structure of a PCS apparatus of 1000Base-X illustrated in FIG. 1.

FIG. 3 illustrates a network structure and functions of a tunable-wavelength passive optical network (T-PON) system;

FIG. 4 illustrates an Ethernet layer architecture of a T-PON system according to an embodiment of the present invention;

FIG. 5 illustrates a network interworking structure of the T-PON system having the Ethernet layer architecture of FIG. 4;

FIG. 6A illustrates a structure of a master PCS apparatus of an OLT according to an embodiment of the present invention;

FIG. 6B illustrates a structure of a slave PCS apparatus of an ONT according to an embodiment of the present invention;

FIG. 7 illustrates a configuration of a wavelength monitoring unit within a master PCS apparatus of an OLT according to the present invention; and

FIG. 8 illustrates a configuration of a wavelength controlling unit within a slave PCS apparatus of an ONT according to the present invention.

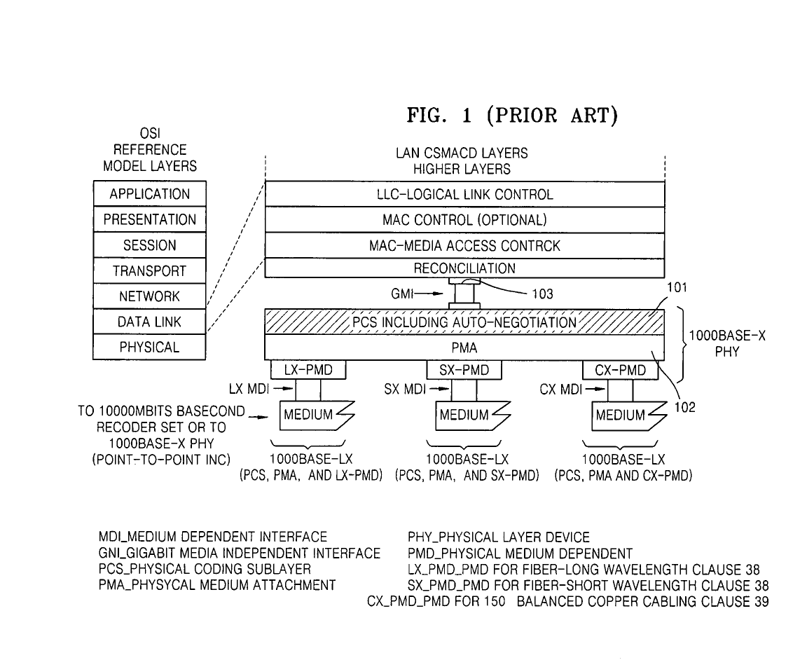

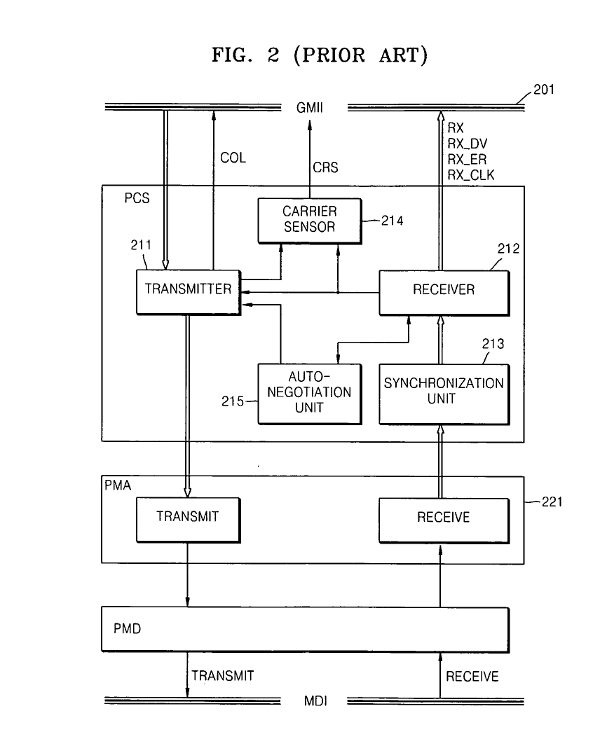

### DETAILED DESCRIPTION OF THE INVENTION

The present invention will be described more fully hereinafter with reference to the accompanying drawings in which exemplary embodiments of the invention are shown.

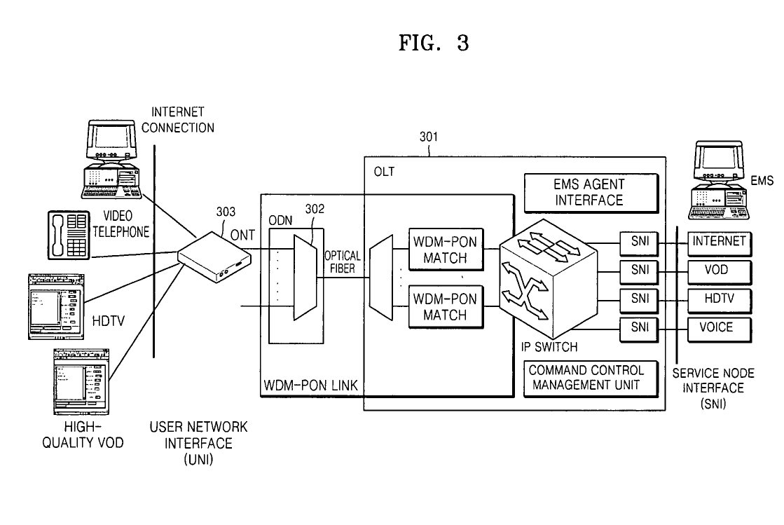

FIG. 3 illustrates a network structure and functions of a tunable-wavelength passive optical network (T-PON) system.

Like the configuration of a conventional optical subscriber network, an optical line terminal (OLT) 301 includes a plurality of match cards having separate wavelengths. A downstream optical signal output from each match card is multiplexed as one optical cable through an output multiplexer (OMUX).and is transmitted to a subscriber terminal.

On the contrary, an upstream optical signal received from the OLT 301 is demultiplexed through an output demultiplexer (ODEMUX) and is separated into several optical signals. That is, single mode light sources modulate lights having N wavelengths for N subscriber terminals into respective downstream signals λᵢ(i:1˜N), and an optical receiver array may be constituted by using PIN —photo diode (PIN-PD) or an avalanche photo diode (APD) and receives an upstream signal λⱼ(j:1˜N) of the subscriber terminal.

An optical multiplexer multiplexes outputs of N single mode light sources and transmits downstream signals to optical fiber, and a demultiplexer performs a reverse function.

Contrary to the OLT, an optical distribution network(ODN) 302 located near a subscriber separates an optical signal having a plurality of wavelengths from one optical cable and transmits the separated optical signals to a corresponding optical network terminal (ONT) for each wavelength.

In this case, a tunable-wavelength light source is located in each ONT, and wavelengths are allocated according to the position of each ONT. The tunable-wavelength light source (for example, planar lightwave circuit-external cavity laser (PLC-ECL)) can be changed into all upstream wavelengths λ₁˜λ_{N} used in a WDM-PON network and receives control signals for tunable wavelengths, for example, heat current and phase section current, are received as digital values.

A tunable-wavelength WDM light source in which allocated wavelengths are arranged, modulates an upstream signal received from physical medium attachment (PMA), and an optical receiver is constituted by using a PIN-PD or an APD, receives an input downstream signal and transmits the received downstream signal to a higher layer PMA.

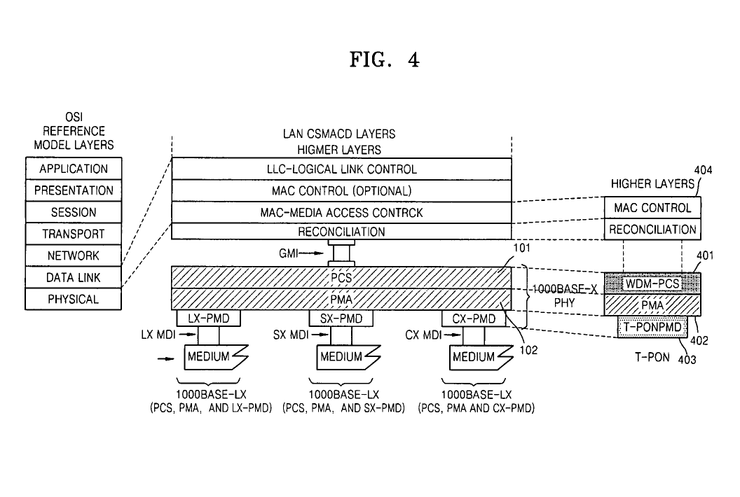

FIG. 4 illustrates an Ethernet layer architecture of a T-PON system according to an embodiment of the present invention.

The present invention provides an Ethernet layer structure in which wavelengths are automatically allocated, without user's intervention, to a colorless ONT in which a tunable-wavelength laser is located at a WDM-PON network in which different wavelengths are allocated to respective subscribers and communications with a central office (CO) are made, and tunable-wavelength light sources of an ONT can be effectively arranged in the allocated wavelengths.

Upstream optical modules of the ONT for providing a subscriber-side interface of WDM-PON should be arranged in predetermined wavelengths allocated to match an array waveguide grating (AWG) disposed on a transmission line and to constitute an upstream transmission line.

Initial wavelength allocation and arrangement based on optical monitoring/control can be automatically and economically without user's intervention.

The Ethernet layer architecture of the T-PON system includes medium access control (MAC) 404, a physical medium attachment (PMA) 402, a physical medium dependent (PMD) 403, and physical coding sublayer (PCS) 401, like IEEE802.3z 1000Base-X.

However, unlike 1000Base-X, the Ethernet layer architecture of the T-PON system employs inherent PMD of WDM-PON in which configuration shape and wavelength information of the PMD 403 are different, and the PCS 401 also has different function and structure.

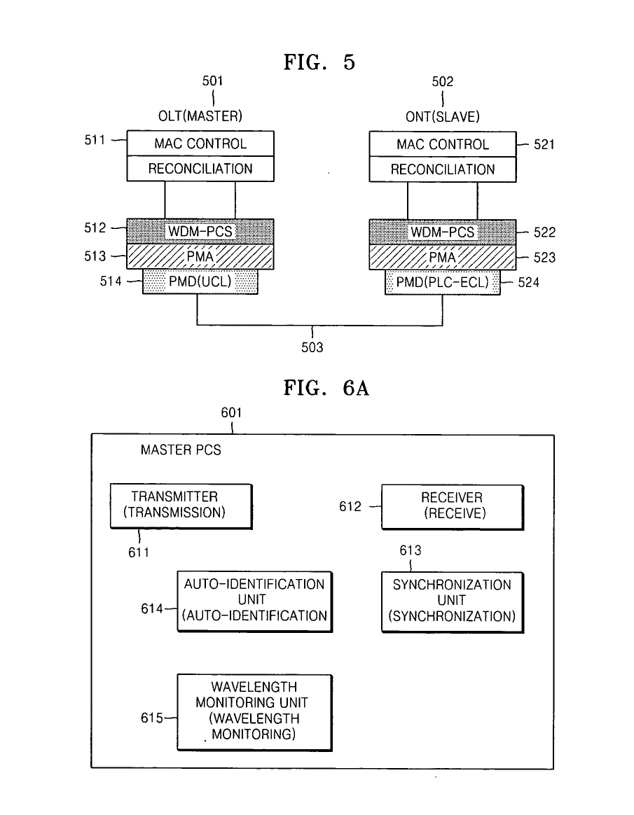

FIG. 5 illustrates a network interworking structure of the T-PON system having the Ethernet layer architecture of FIG. 4.

Unlike 1000Base-Z, an optical line terminal (OLT) 501 serves as a master, and an optical network terminal (ONT) 502 serves as a slave according to the function of physical coding sublayer (PCS) and the function of physical medium dependent (PMD).

PMD 514 of the OLT 501 monitors an upstream optical wavelength through an optical signal transmitted from the ONT 502. PMD 524 of the ONT 502 adopts a tunable-wavelength light source that can change an upstream optical wavelength of a transmitter, and a light source of a receiver can be received regardless of wavelengths.

Thus, an OLT PCS 512 (master PCS) monitors an upstream optical wavelength, determines whether the wavelength is proper, to decide adjustment/maintenance and transmits a proper message as a result of the decision to the ONT 502 downwards.

The ONT PCS 522 interprets the message transmitted from the OLT PCS 512 and controls an external current of the PMD to perform maintenance/adjustment of wavelengths. Thus, only a communication channel between the OLT PCS 512 and the ONT PCS 522 is maintained until wavelength initialization is completed so that any message is not transmitted to higher layers.

This procedure is included in a link setting operation like the auto-negotiation operation of 1000Base-X. In this structure, an OLT MAC 511 and an ONT MAC 521 have the same function as that of 1000Base-X, and there is no change in functions of PMA 513 and 523.

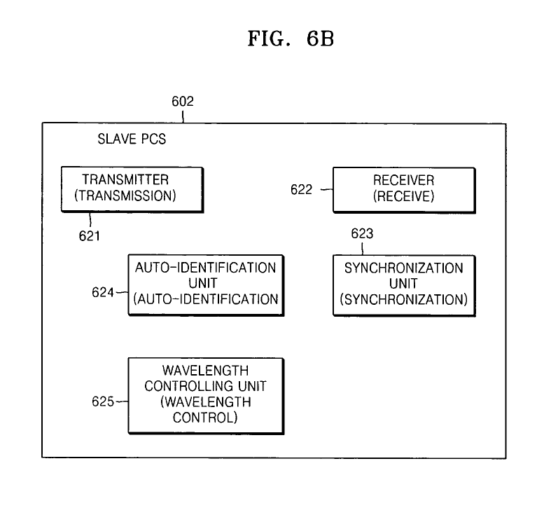

FIGS. 6A and 6B illustrate the structure of a PCS apparatus of a T-PON system according to an embodiment of the present invention.

A tunable-wavelength light source is located in an ONT of WDM-PON and the ONT of WDM-PON is connected to an array waveguide grating (AWG) of a remote node (RN) via an optical link.

Thus, a WDM-PON system should support a series of initialization function of allocating wavelengths to an upstream light source and arranging the allocated wavelengths when connecting networks of an ONT.

A wavelength initialization method of a tunable-wavelength ONT light source according to the present invention includes a different frame layer initialization method from an existing optical layer initialization method.

In the frame layer initialization method, allocated wavelengths are advertised as digital information and arrangement is tried based on the digital information. While trying arrangement, the ONT transmits wavelength control as a digital value to an OLT, and the OLT decides an optimum control value based on a received optical power transmitted to the OLT which is a remote node (RN) via an AWG, and control information NOCP to transmit the decided optimum control value to the ONT.

In the frame layer initialization method according to the present invention, an ONT optical signal is decided independently with an optical signal transmitted to the ONT from the OLT. Thus, the frame layer initialization method can support wavelength initialization and arrangement of a planar lightwave circuit-external cavity laser (PLC-ECL)-based ONT that has been recently studied.

Besides, a remote monitoring/control function of an ONT transmission optical wavelength using an AWG on a line can replace a high-priced wavelength locker function.

The PCS apparatus according to the present invention includes a master PCS apparatus 601 of FIG. 6A and a slave PCS apparatus 602 of FIG. 6B, unlike a conventional PCS apparatus.

The master PCS apparatus 601 performs the same transmission and reception functions of five PCS functions defined by the IEEE 802.3 1000Base-X standard and performs an additional master function for wavelength initialization of a tunable-wavelength ONT.

That is, when a link between an OLT and an ONT is initialized, wavelength information allocated to an ONT light source is cyclically transmitted, and information transmitted from the slave PCS apparatus 602 of the ONT is received in a frame format.

In addition, control information received from the ONT is interpreted in real time, an optimum ONT light condition is extracted, and the ONT is re-transmitted through a control frame. In this case, the slave PCS apparatus 602 interprets the control frame transmitted from the master PCS apparatus 601 and controls a current of the ONT light source through the control frame.

If wavelength initialization is completed by repeating the above procedure, a link between the OLT and the ONT is normally set and data transmission up to a mutual MAC layer is possible.

FIG. 6A illustrates the structure of a master PCS apparatus 601 according to an embodiment of the present invention.

Referring to FIG. 6A, the master PCS apparatus 601 includes a transmitter 611, a receiver 612, an auto-identification unit 614, a synchronization unit 613, and a wavelength monitoring unit 615.

The transmitter 611 transmits 8-bit data transmitted to a GMII interface from a higher MAC layer to a 10-bit TBI interface through an 8B/10 encoding method. Contrary to this, the receiver 612 performs the function of 8B/10B decoding.

The auto-identification unit 614 and the wavelength monitoring unit 615 are characteristic portions of the present invention and performs an auto-negotiation function of 1000Base-X and exchange, monitoring and control functions of wavelength information needed in a T-PON system.

The auto-negotiation function has been described above and thus a description thereof will be omitted.

The wavelength monitoring function is to interpret a frame received from the ONT and to compare and monitor whether the interpreted frame is identical with wavelength information allocated to a corresponding ONT (615). If control information is not identical with the wavelength information, the auto-identification unit 614 inserts wavelength control information in the frame and transmits the wavelength control information to the ONT while not driving a transmitter and a receiver.

In this case, the wavelength control information is not defined in the 1000Base-X standard but a reserved control frame is used. This procedure is repeated until the wavelength information of the optical signal transmitted from the ONT is identical with the control information. If the wavelength information is identical with the control information, the auto-identification unit 614 advertises to each functional unit that link setting is completed, and normal data transmission and reception is performed.

FIG. 6B illustrates the structure of a slave PCS apparatus 602 according to an embodiment of the present invention.

Referring to FIG. 6B, the slave PCS apparatus 602 includes a transmitter 621, a receiver 622, an auto-identification unit 624, a synchronization unit 623, and a wavelength controlling unit 625. Like the master PCS apparatus 601 of FIG. 6A, the transmitter 621 transmits 8-bit data transmitted to a GMII interface from a higher MAC layer to a 10-bit TBI interface through an 8B/10 encoding method.

Contrary to this, the receiver 622 performs the function of 8B/10B decoding.

The auto-identification unit 624 exchanges a frame with the master PCS apparatus 601 and performs a series of operations until link setting is completed.

Wavelength allocation information transmitted from the OLT is interpreted and a wavelength value corresponding to the interpreted wavelength allocation information is transmitted to the wavelength controlling unit 625. The wavelength controlling unit 625 controls a transmission light source of PMD using a current value that is proper to a wavelength value.

If the transmitted optical signal is interpreted by the master PCS apparatus and a proper control frame is transmitted to the ONT, the auto-identification unit 624 interprets the frame again and receives the result of determining whether a wavelength of the transmitted optical signal is identical with allocated wavelength information.

If the result value is normal, the present control value is maintained and if the result value is abnormal, the wavelength controlling unit 625 controls the PMD light source using a proper current value again. Setting of a link between the ONT and the OLT is completed by repeating the above procedure. A series of operations until link setting is completed is performed like in the OLT.

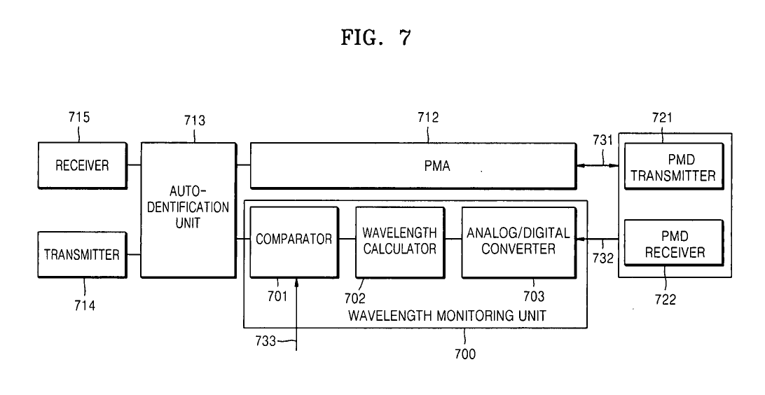

FIG. 7 illustrates a configuration of a wavelength monitoring unit within the master PCS apparatus according to the present invention.

An analog value of an optical signal received through PMD is converted into a digital value by an analog/digital converter 703. The converted value is calculated into a wavelength value through a predetermined database (702).

The calculated wavelength value is compared with a wavelength value allocated to a corresponding ONT (701), and the result of the comparison is transmitted to the auto-identification unit 713, and whether link setting and wavelength control are performed is determined according to the result of comparison.

Control information generated by the auto-identification unit 713 is transmitted downwards through PMA 712 and a PMD transmitter 721 and is finally transmitted to a slave PCS apparatus within an ONT.

Whether the above procedure is performed only in an initialization step or usually performed while a system operates can be selected and should not affect the operating performance of the system.

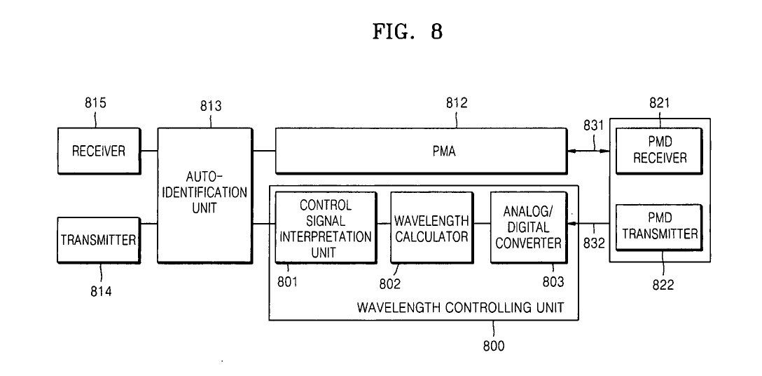

FIG. 8 illustrates a configuration of a wavelength controlling unit within the slave PCS apparatus according to the present invention.

An optical signal received by a PMD receiver 821 is transmitted to an auto-identification unit 813 within the slave PCS apparatus, and control information transmitted from an OLT is interpreted. If wavelength control is necessary as a result of the interpretation, the auto-identification unit 813 transmits information to a control signal interpretation unit 801 within the wave controlling unit 800, and a wavelength calculator 802 converts a wavelength value into a proper digital value.

An analog/digital converter 803 converts an analog current value to adjust a wavelength of a light source of a PMD transmitter 822.

The above procedure is repeated until normal information is received from an OLT, and wavelength initialization is completed, auto-negotiation function information exchange is completed, and a normal link setting procedure is completed.

As described above, according to the present invention, an optical network terminal (ONT) transmits wavelength control as a digital value to an optical line terminal (OLT) while trying arrangement, the OLT decides an optimum control value based on a received optical power transmitted to the OLT which is a remote node (RN) via an array waveguide grating (AWG), and control information NOCP, transmits the optimum control value to the ONT and decides an ONT optical signal independently with an optical signal transmitted to the ONT from the OLT such that wavelength initialization and arrangement of a planar lightwave circuit-external cavity laser (PLC-ECL)-based ONT are supported.

A remote monitoring/control function of an ONT transmission optical wavelength using an AWG on a line replaces a high-priced wavelength locker function and therefore, it is expected that network constitution costs can be remarkably reduced. In particular, only a physical coding sublayer (PCS) function within an Ethernet layer architecture is compensated for and therefore, it is expected that a low-priced a tunable-wavelength passive optical network (T-PON) system can be implemented.

The present invention supports effective wavelength initialization and arrangement of an ONT in which the wavelength of an ONT light source is initialized and is maintained without the intervention of a medium access control (MAC) layer or an external system processor.

The present invention supports physical medium dependent (PMD) of a wavelength division multiplexing (WDM)—passive optical network (WDM-PON) technology in which a tunable-wavelength light source is located in an ONT. Thus, the present invention can support Gigabit Ethernet having the function of selectively allocating and arranging wavelengths of the ONT at an initial stage.

While the present invention has been particularly shown and described with reference to exemplary embodiments thereof, it will be understood by those skilled in the art that various changes in form and details may be made therein without departing from the spirit and scope of the invention as defined by the following claims.

What is claimed is:

1. A PCS (physical coding sublayer) apparatus for a network-based T-PON (tunable-wavelength passive optical network) system of Ethernet including an ONT (optical network terminal) having a tunable-wavelength light source, the PCS apparatus comprising:
a wavelength monitoring unit extracting wavelength information from a digital frame signal transmitted from the ONT and monitoring whether the wavelength information is identical with wavelength information allocated to a light source of the ONT; and
an auto-identification unit, if the wavelength information is not identical with the wavelength information allocated to the light source of the ONT, adding wavelength control information to the digital frame signal and transmitting the wavelength control information to the ONT.

2. The PCS apparatus of claim 1, further comprising:
a transmitter, if the wavelength information is identical with the wavelength information allocated to the light source of the ONT, encoding data transmitted from the ONT using a predetermined manner and transmitting the data to a higher MAC (medium access control) layer; and
a receiver decoding data of the MAC layer using a predetermined manner and receiving the data.

3. The PCS apparatus of claim 1, wherein the wavelength control information of the auto-identification unit is added to a reserved frame of the digital frame signal.

4. The PCS apparatus of claim 1, wherein the wavelength monitoring unit comprises:
an analog/digital converter converting an optical signal transmitted from the ONT into a digital frame signal;
a wavelength calculator extracting wavelength information from the digital frame signal; and
a comparator comparing whether the wavelength information is the wavelength information allocated to a light source of the ONT.

5. An Ethernet layer architecture for a network-based T-PON (tunable-wavelength passive optical network) system of Ethernet including an ONT (optical network terminal) having a tunable-wavelength light source, the Ethernet layer architecture comprising:
a PMD (physical medium dependent) receiver receiving an optical signal transmitted from the ONT;
a PCS (physical coding sublayer) extracting wavelength information from the received optical signal, monitoring whether the wavelength information is identical with wavelength information allocated to a light source of the ONT, and if the wavelength information is not identical with the wavelength information allocated to the light source of the ONT, adding wavelength control information to the digital frame signal;
a PMA (physical medium attachment) changing the digital frame signal to which the wavelength control information is added and which has a parallel structure, into a serial structure; and
a PMD transmitter converting the serial-structure digital frame signal into an optical signal and transmitting the optical signal.

6. The Ethernet layer architecture of claim 5, wherein the PCS comprises:
a wavelength monitoring unit changing the optical signal transmitted from the ONT into a digital frame signal, extracting wavelength information from the digital frame signal and monitoring whether the wavelength information is the wavelength information allocated to the light source of the ONT;
an auto-identification unit, if the wavelength information is not identical with the wavelength information allocated to the light source of the ONT, adding wavelength control information to the digital frame signal;
a transmitter, if the wavelength information is identical with the wavelength information allocated to the light source of the ONT, encoding data received from the ONT using a predetermined manner and transmitting the data to a higher MAC (medium access control) layer; and
a receiver decoding data of the MAC layer using a predetermined manner and receiving the data.

7. A PCS (physical coding sublayer) apparatus for a network-based T-PON (tunable-wavelength passive optical network) system of Ethernet including an ONT (optical network terminal) having a tunable-wavelength light source, the PCS apparatus comprising:
an auto-identification unit extracting wavelength control information from a digital frame signal transmitted from an OLT (optical line terminal); and
a wavelength controlling unit converting the extracted wavelength control information into a current signal which is an analog signal, and controlling a wavelength of a tunable-wavelength light source of the ONT.

8. The PCS apparatus of claim 7, further comprising:
a transmitter, if the wavelength of the tunable-wavelength light source of the ONT is identical with the wavelength information allocated to the light source of the ONT, encoding data received from a light source of the OLT using a predetermined manner and transmitting the data to a higher MAC (medium access control) layer; and
a receiver decoding data of the MAC layer using a predetermined manner and receiving the data.

9. The PCS apparatus of claim 7, wherein the wavelength controlling unit comprises:
a control signal interpretation unit extracting wavelength information corresponding to the wavelength control information;
a wavelength calculator converting the extracted wavelength information into a predetermined digital value; and
an analog/digital converter converting the digital value into a current signal which is an analog signal, and controlling the wavelength of the tunable-wavelength light source of the ONT.

10. An Ethernet layer architecture for a network-based T-PON (tunable-wavelength passive optical network) system of Ethernet including an ONT (optical network terminal) having a tunable-wavelength light source, the Ethernet layer architecture comprising:
a PMD (physical medium dependent) receiver receiving an optical signal transmitted from an OLT (optical line terminal);
a PMA (physical medium attachment) converting the optical signal into a digital frame signal;
a PCS (physical coding sublayer) extracting wavelength control information from the digital frame signal transmitted from the OLT and converting the extracted wavelength control signal into a current signal which is an analog signal, to control a wavelength of a tunable-wavelength light source of the ONT; and
a PMD transmitter of the tunable-wavelength light source outputting an optical signal with a wavelength corresponding to the current signal.

11. The Ethernet layer architecture of claim 10, wherein the PCS comprises:
an auto-identification unit extracting wavelength control information from a digital frame signal transmitted from the OLT;
a wavelength controlling unit converting the extracted wavelength control information into a current signal which is an analog signal, to control a wavelength of the tunable-wavelength light source of the ONT;
a transmitter, if the wavelength of the tunable-wavelength light source of the ONT is identical with the wavelength information allocated to the light source of the ONT, encoding data received from a light source of the OLT using a predetermined manner and transmitting the data to a higher MAC (medium access control) layer; and
a receiver decoding data of the MAC layer using a predetermined manner and receiving the data.
